(19) United States
(12) Patent Application Publication
(10) Pub. No.: US 2026/0031095 A1
(43) Pub. Date: Jan. 29, 2026

(54) LOW-COMPLEXITY MAXIMUM NORMALIZED AUTOCORRELATION ESTIMATION OF AUDIO SIGNALS

(71) Applicant: Nuvoton Technology Corporation, Hsinchu (TW)

(72) Inventors: Powen Ru, Gaithersburg, MD (US); Peter Dinh, San Jose, CA (US)

(21) Appl. No.: 18/783,590

(22) Filed: Jul. 25, 2024

(51) Int. Cl. G10L 25/06; G10L 25/09; G10L 25/90

(52) U.S. Cl. CPC G10L 25/06; G10L 25/09; G10L 25/90

(57) ABSTRACT

A system includes: a microphone configured to receive an acoustic signal; an ADC configured to convert the acoustic signal into a digital form; and a processor configured to: trim a window of the digital form; locate positive-bound zero-crossings or negative-bound zero-crossings; locate local maxima or local minima between each of the two neighboring positive-bound zero-crossings or between each of the two neighboring negative-bound zero-crossings; identify an overall maximum; determine at least one valid sample range; determine an amplitude threshold; screen the local maxima or the local minima based on the at least one valid sample range and the amplitude threshold to identify a first set of local maxima or a first set of local minima; select a second number of top local maxima or a second number of bottom local minima; expand the first set of lags; calculate normalized autocorrelations; and determine an approximated maximum normalized autocorrelation.

### FIELD

This application generally relates to a maximum normalized autocorrelation approximation method. More particularly, the present application relates to a maximum normalized autocorrelation approximation method of audio signals based on a subset of valid lag set.

### BACKGROUND

An audio signal is an electronic representation of sound waves, which are longitudinal waves travelling through the medium. An audio signal can be captured, transmitted, stored, or processed by electronic devices. It contains information about the sound, such as its frequency, amplitude, and phase, that allows us to perceive and reproduce auditory experiences. Audio signal processing is a subfield of signal processing that is concerned with the electronic manipulation of audio signals. The energy contained in audio signals is typically measured in decibels. As audio signals may be represented in either digital or analog format, processing ma occur in either domain. Analog processors operate directly on the electrical signal, while digital processors operate mathematically on its digital representation.

### BRIEF SUMMARY OF THE INVENTION

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a system. The system includes: a microphone configured to receive an acoustic signal; an analog-to-digital converter (ADC) connected to the microphone and configured to convert the acoustic signal into a digital form of the acoustic signal; and a processor connected to the ADC. The processor is configured to: trim a window of the digital form of the acoustic signal, the window being characterized by a first number of samples; locate positive-bound zero-crossings or negative-bound zero-crossings of the digital form of the acoustic signal within the window; locate local maxima or local minima between each of the two neighboring positive-bound zero-crossings or between each of the two neighboring negative-bound zero-crossings; identify an overall maximum from the local maxima or an overall minimum from the local minima; determine at least one valid sample range; determine an amplitude threshold; screen the local maxima or the local minima based on the at least one valid sample range and the amplitude threshold to identify a first set of local maxima or a first set of local minima; select a second number of top local maxima from the first set of local maxima or a second number of bottom local minima from the first set of local minima, samples corresponding to the second number of top local maxima defining a first set of lags with respect to the overall maximum, or samples corresponding to the second number of bottom local minima defining the first set of lags with respect to the overall minimum; expand the first set of lags by including a third number of neighboring samples of the samples corresponding to the second number of top local maxima or a third number of neighboring samples of the samples corresponding to the second number of bottom local minima; calculate normalized autocorrelations based on the expanded first set of lags; and determine an approximated maximum normalized autocorrelation based on the calculated normalized autocorrelations.

In some embodiments, the at least one valid sample range corresponds to a typical human pitch range.

In some embodiments, the at least one valid sample range and the amplitude threshold define at least one target region.

In some embodiments, screening the local maxima or the local minima is based on the at least one target region, and local maxima outside the at least one target region or local minima outside the at least one target region are screened out.

In some embodiments, the first set of lags further comprises previous lags.

In some embodiments, the second number is between four and five.

In some embodiments, the third number is between two and four.

In some embodiments, the processor is further configured to: analyze one or more pitch characteristics of the acoustic signal based on the approximated maximum normalized autocorrelation.

Another aspect includes a method. The method includes the following steps: obtaining a digital form of an acoustic signal; trimming a window of the digital form of the acoustic signal, the window being characterized by a first number of samples; locating positive-bound zero-crossings or negative-bound zero-crossings of the digital form of the acoustic signal within the window; locating local maxima or local minima between each of the two neighboring positive-bound zero-crossings or between each of the two neighboring negative-bound zero-crossings; identifying an overall maximum from the local maxima or an overall minimum from the local minima; determining at least one valid sample range; determining an amplitude threshold; screening the local maxima or the local minima based on the at least one valid sample range and the amplitude threshold to identify a first set of local maxima or a first set of local minima; selecting a second number of top local maxima from the first set of local maxima or a second number of bottom local minima from the first set of local minima, samples corresponding to the second number of top local maxima defining a first set of lags with respect to the overall maximum, or samples corresponding to the second number of bottom local minima defining the first set of lags with respect to the overall minimum; expanding the first set of lags by including a third number of neighboring samples of the samples corresponding to the second number of top local maxima or a third number of neighboring samples of the samples corresponding to the second number of bottom local minima; calculating normalized autocorrelations based on the expanded first set of lags; and determining an approximated maximum normalized autocorrelation based on the calculated normalized autocorrelations.

In some embodiments, obtaining the digital form of the acoustic signal comprises: receiving, by a microphone, the acoustic signal; and converting, by an analog-to-digital converter (ADC) connected to the microphone, the acoustic signal into the digital form of the acoustic signal.

In some embodiments, the at least one valid sample range corresponds to a typical human pitch range.

In some embodiments, the at least one valid sample range and the amplitude threshold define at least one target region.

In some embodiments, screening the local maxima or the local minima is based on the at least one target region, and local maxima outside the at least one target region or local minima outside the at least one target region are screened out.

In some embodiments, the first set of lags further comprises previous lags.

In some embodiments, the second number is between four and five.

In some embodiments, the third number is between two and four.

In some embodiments, the method further includes: analyzing one or more pitch characteristics of the acoustic signal based on the approximated maximum normalized autocorrelation.

Another aspect includes a system. The system includes: a microphone configured to receive an acoustic signal; an analog-to-digital converter (ADC) connected to the microphone and configured to convert the acoustic signal into a digital form of the acoustic signal; and a processor connected to the ADC. The processor is configured to: locate positive-bound zero-crossings or negative-bound zero-crossings of the digital form of the acoustic signal; locate local maxima or local minima between each of the two neighboring positive-bound zero-crossings or between each of the two neighboring negative-bound zero-crossings; identify an overall maximum from the local maxima or an overall minimum from the local minima; determine at least one valid sample range; determine an amplitude threshold; screen the local maxima or the local minima based on the at least one valid sample range and the amplitude threshold to identify a first set of local maxima or a first set of local minima; select a second number of top local maxima from the first set of local maxima or a second number of bottom local minima from the first set of local minima, samples corresponding to the second number of top local maxima defining a first set of lags with respect to the overall maximum, or samples corresponding to the second number of bottom local minima defining the first set of lags with respect to the overall minimum; calculate normalized autocorrelations based on the first set of lags; and determine an approximated maximum normalized autocorrelation based on the calculated normalized autocorrelations.

In some embodiments, the processor is further configured to: expand the first set of lags by including a third number of neighboring samples of the samples corresponding to the second number of top local maxima or a third number of neighboring samples of the samples corresponding to the second number of bottom local minima.

In some embodiments, the at least one valid sample range and the amplitude threshold define at least one target region.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts the waveform of an audio signal with its corresponding maximum normalized autocorrelations and approximated maximum normalized autocorrelations according to various embodiments of the present application.

FIG. 2 depicts a windowed audio signal waveform with 256 samples according to some aspects of the present disclosure.

FIG. 3 depicts another windowed waveform with fewer zero-crossings in another example in accordance with some aspects of the present disclosure.

FIG. 4 depicts a block diagram illustrating the low-complexity maximum normalized autocorrelation approximation method in accordance with aspects of the present disclosure.

FIG. 5 depicts a scatter plot showing the distribution of the approximated maximum normalized autocorrelations (MNAC) with respect to the corresponding original maximum normalized autocorrelations (MNAC) according to some aspects of the present disclosure.

FIG. 6 depicts a bar graph showing the averaged differences between original maximum normalized autocorrelations and the corresponding approximations according to some aspects of the present disclosure.

FIG. 7 depicts an example of a system in accordance with some aspects of the present disclosure.

### DETAILED DESCRIPTION OF THE DISCLOSURE

The following disclosure provides many different embodiments, or examples, for implementing different features of the subject matter provided. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Some embodiments of the disclosure are described. Additional operations can be provided before, during, and/or after the stages described in these embodiments. Some of the stages that are described can be replaced or eliminated for different embodiments. Some of the features described below can be replaced or eliminated and additional features can be added for different embodiments. Although some embodiments are discussed with operations performed in a particular order, these operations may be performed in another logical order.

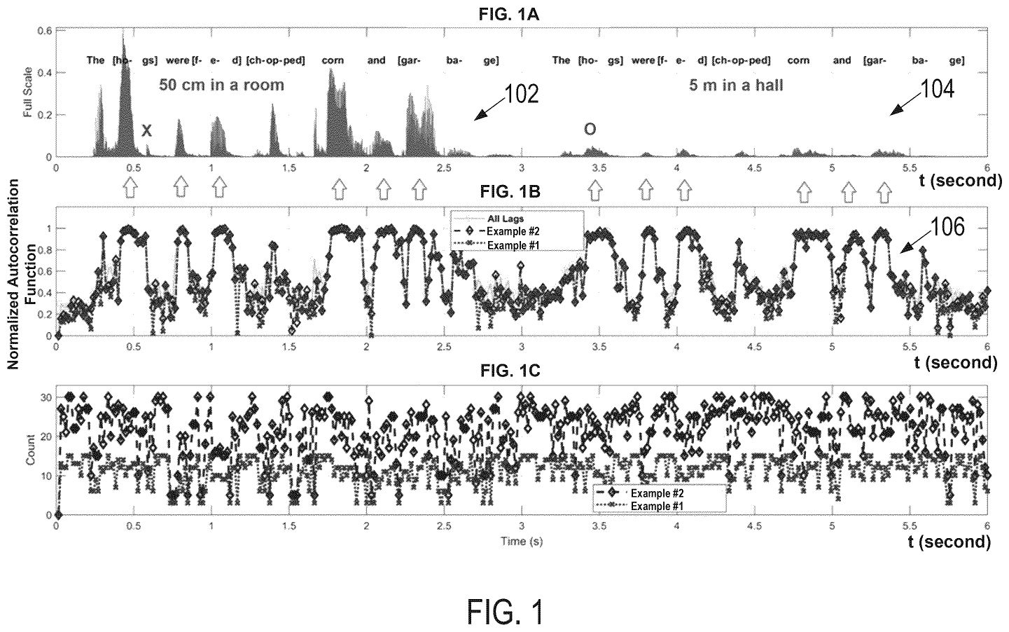

FIG. 1 depicts the waveform of an audio signal (may also be referred to as an “acoustic signal,” and these two terms may be used interchangeably throughout the disclosure) with its corresponding maximum normalized autocorrelations and approximated maximum normalized autocorrelations according to various embodiments of the present application. FIG. 1A shows an audio signal consisting of the waveforms of two sentences 102 and 104 produced by a mouth simulator with exactly the same volume. The waveform of the first sentence 102 (between 0 and 3s, as shown in FIG. 1A) was produced 0.5 meters away from a microphone positioning in a room, while the waveform of the second sentence 104 (between 3s and 6s, as shown in FIG. 1A) was produced 5 meters away from the microphone but positioning in a bigger hall. As shown in FIG. 1A, the amplitude of the waveform of the second sentence 104 is smaller than the amplitude of the waveform of the first sentence 102 due to propagation attenuation

It may be desirable to apply an automatic gain control (AGC) so that the two sentences would have about the same volume. AGC is essentially a self-adjusting volume knob that automatically regulates the strength of an audio signal. AGC continuously monitors the incoming audio signal's strength and dynamically adjusts the gain (amplification) of the audio signal to keep it within a desired range based on the incoming audio signal's strength. As a result, a consistent listening experience can be achieved because no more jumping up and down to adjust the volume is needed for quite whispers and loud shouts, respectively. In addition, the signal-to-noise ratio can be improved because AGC can boost the gain for weak signals, making weak signals more audible compared to background noise. Thus, AGC is used in various types of applications, such as telephony, radio broadcasting, hearing aids, speech recognition, and so on.

In order to conduct an AGC process, the voice peaks (or more specifically, vowel peaks) need to be identified so as to tune the gain accordingly. In the example shown in FIG. 1A, as the amplitude of the waveform of the second sentence 104 is relatively low, it is hard to distinguish a voice peak (e.g., denoted as “O” at 3.5s, as shown in FIG. 1A) from background noise (e.g., annoying “breathing” or “pumping”) that is undesirable to boost.

A good way to identify voice peaks is to look for the pitch feature. In audio signal processing (or more specifically, speech processing), pitch is a key factor extracted from an audio signal. Pitch is determined by the rate of vibration of a human's vocal cords. Faster vibrations produce higher pitches, while slower vibrations produce lower pitches. A pitch period is the smallest repeating unit of a voice sound wave. It is directly linked to the perceived pitch of the sound. The frequency (i.e., how often the voice sound wave repeats itself in one second) of the pitch period determines the perceived pitch of the sound. A faster repetition rate (shorter pitch period) corresponds to a higher pitch, and vice versa.

The pitch feature mentioned above can be characterized by high correlation between one pitch period and its neighboring pitch period. Autocorrelation may be used to estimate pitch period in speech processing. Autocorrelation essentially measures how similar an audio signal is to a shifted version of itself. In voiced speech, when the audio signal is shifted by one pitch period, the audio signal is substantially aligned with itself, leading to a high correlation value (in the form of a “peak”) at that specific delay. High correlation between pitch periods strengthens the accuracy of techniques that rely on pitch period estimation, such as speech recognition or voice analysis tools.

However, since real speech is not perfectly periodic (because, for example, vocal cord vibrations can vary slightly within a pitch period due to factors like breathing or speaking style), a slight decrease in correlation between neighboring pitch periods may occur. Background noise can also introduce some randomness to the audio signal, thereby reducing the correlation between neighboring pitch periods. In contrast, correlation wouldn't be meaningful for unvoiced sounds, as they lack a defined pitch period and exhibit more random variations.

The maximum normalized autocorrelation (“MNAC”) for an audio signal refers to the highest peak value obtained when calculating the normalized autocorrelation function. After being normalized, the autocorrelation values are scaled between zero and one, with a value of zero indicating no correlation and a value of one indicating perfect correlation (i.e., complete overlap). Thus, maximum normalized autocorrelation, as a value, represents the highest degree of similarity between the original signal and any of its shifted versions. In voiced sounds (e.g., vowels), the maximum normalized autocorrelation typically occurs at a delay equal to the pitch period. This is because the pitch period represents the most repetitive unit of the waveform of voiced sounds. In contrast, for non-periodic signals (e.g., noise or transient sounds), the maximum normalized autocorrelation will likely be lower and occur at a delay close to zero (indicating similarity to itself with no shift). Due to these characteristics, the maximum normalized autocorrelation can be used as a clue to identify the pitch period in voiced speech, aiding in pitch detection techniques or algorithms. Analyzing the overall shape of the normalized autocorrelation function can also reveal information about the periodicity and complexity of the signal.

FIG. 1B shows a normalized autocorrelation function 106 according to various embodiments of the present application. As shown in FIG. 1B, the amplitude of the normalized autocorrelation function 106 is between zero and one. The maximum locations (i.e., timing in this specific example shown in FIG. 1B) of the normalized autocorrelation function 106 corresponds to voice peaks of the waveform of the first sentence 102 and the waveform of the second sentence 104, as shown by the upward arrows in FIG. 1. As shown in FIGS. 1A and 1B, although the amplitude (i.e., volume) of the waveform of the second sentence 104 is relatively low, the voice peaks can still be effectively identified by way of maximum normalized autocorrelation.

A conventional method to calculate a maximum normalized autocorrelation is by calculating the normalized correlations between a segment of samples (after being sampled and digitalized) and many shifted (i.e., lagged) segments having a range corresponding to human pitch range. In one example, the range corresponding to human pitch range is 20 to 128 samples at 8 kHz (corresponding to 62.5 Hz to 400 Hz). This requires calculation of 109 normalized correlations (shifted by one sample, shifted by two samples, shifted by three samples, . . . ), which is an expensive computational task, consumes much computational resources, and generates much heat.

Thus, it would be desirable to reduce the number of normalized correlations without sacrificing the accuracy, especially when the maximum normalized autocorrelations are high (e.g., greater than 0.85 in the example shown in FIG. 1B), so as to identify interested voice peaks. An approximation approach is therefore provided according to the present disclosure. The approximation approach disclosed herein and detailed below is generally applicable to any applications where only the accuracy of high maximum normalized autocorrelations is required.

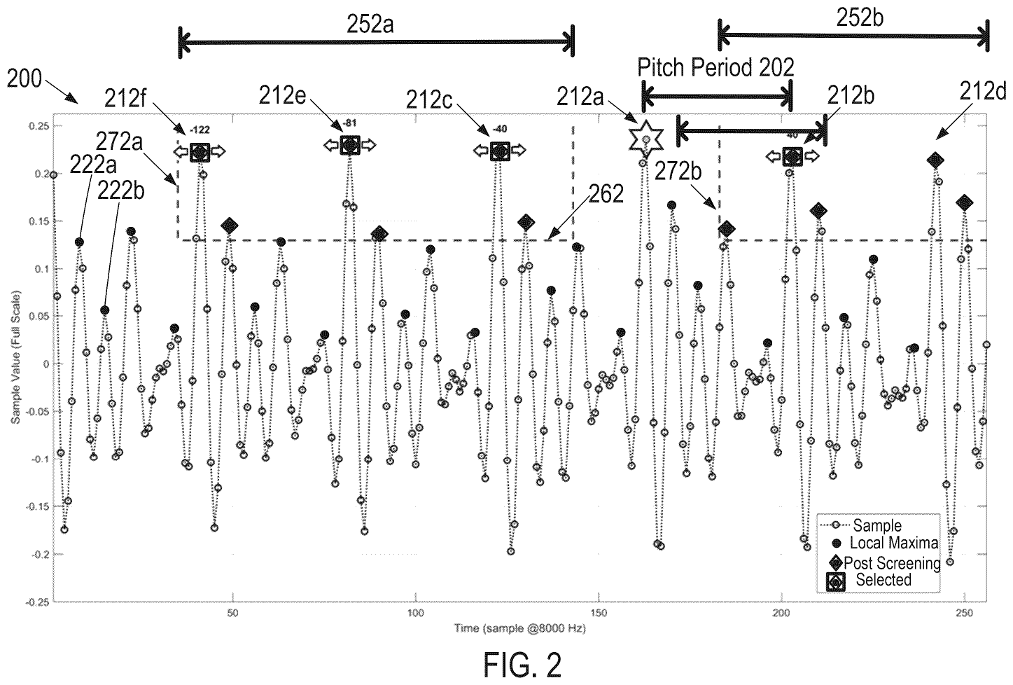

FIG. 2 depicts a windowed audio signal waveform 200 with 256 samples according to some aspects of the present disclosure. In the example shown in FIG. 2, the audio signal waveform 200 includes 256 samples, sampled at 8000 Hz, and the corresponding amplitude varies in the pattern shown in FIG. 2. As mentioned above, one way to calculate a maximum normalized autocorrelation is by calculating the normalized correlations between a segment of samples and many shifted (i.e., lagged) segments. As shown in FIG. 2, the pitch period 202 is about forty samples, meaning that the smallest repeating unit of the waveform 200 is about forty samples. In the example shown in FIG. 2, the peak 212a appears at about the 165^{th} sample and is used as the benchmark. If the waveform is shifted to the right by about forty samples to the right, the peak 212a is substantially aligned with the peak 212b. This is because the shift or lag (i.e., about forty samples) is equal to the pitch period 202. The waveform becomes very similar to this shifted version of itself when the shift is about forty samples, and the normalized autocorrelation function has a peak value when the shift is about “+40” samples (here, “+” means the waveform is shifted in the forward direction).

Similarly, if the waveform is shifted to the left by about forty samples, the peak 212a is substantially aligned with the peak 212c. This is because the shift or lag (i.e., about forty samples) is equal to the pitch period 202. The waveform becomes very similar to this shifted version of itself when the shift is about forty samples to the left, and the normalized autocorrelation function has a peak value when the shift is about “−40” samples (here, “−” means the waveform is shifted in the backward direction).

Likewise, the normalized autocorrelation function has a peak value when the shift is about “+80” samples (aligning with the peak 212d), about “−81” samples (aligning with the peak 212e), and about “−122” samples (aligning with the peak 212f). In other words, these shifts correspond to the maximum normalized autocorrelation, which can be used as a clue to identify the pitch period 202 in the audio signal waveform 200, aiding in pitch detection techniques or algorithms.

However, as mentioned above, calculating the entire normalized autocorrelation function requires calculating the correlation every time shifting the audio signal waveform 200 by one sample, which is an expensive computational task and consumes much computational resources. Thus, an approximation approach is therefore provided according to the present disclosure.

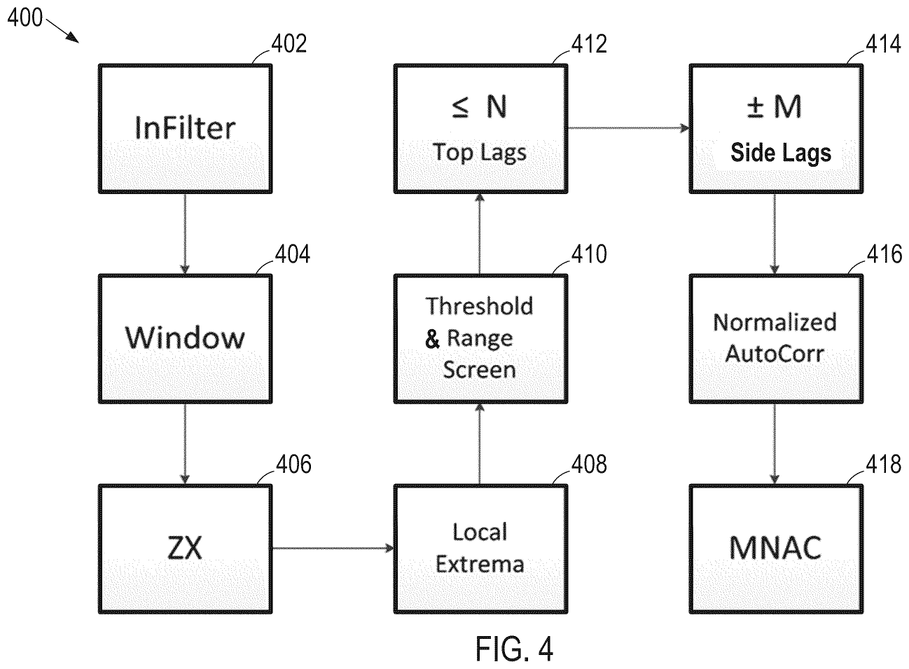

FIG. 4 depicts a block diagram illustrating the low-complexity maximum normalized autocorrelation approximation method 400 in accordance with aspects of the present disclosure. At step 402, the audio signal is fed to an input filter (denoted as “InFilter” in FIG. 4). The input filter suppresses the DC offset of a digitally sampled waveform of the audio signal to generate a filtered digitally sampled waveform, which has been digitally sampled by an analog-to-digital converter based on the analog waveform. In some implementations, the input filter may also boost or attenuate certain frequency bands to adjust the tonal balance of the sound or remove unwanted background noise.

At step 404, the filtered digitally sampled waveform is windowed (i.e., trimming or selecting a window of the filtered digitally sampled waveform). In the example shown in FIG. 2, the window corresponds to 256 samples, namely from the 1^{st} sample to the 256^{th} sample. In other words, the windowed waveform 200 shown in FIG. 2 has the window size of 256 samples. It should be understood that other window sizes may be employed in other embodiments as needed.

At step 406, positive-bound (or positive-going) zero-crossings of the windowed waveform 200 are located. A positive-bound zero-crossing is a point where the sign of the windowed waveform 200 changes from negative to positive. In the example shown in FIG. 2, the first positive-bound zero-crossing is located between the 6^{th} sample and the 7^{th} sample, and the second positive-bound zero-crossing is located between the 13^{th} sample and the 14^{th} sample. All positive-bound zero-crossings can be located in a similar manner accordingly.

At step 408, local maxima (denoted as a solid circle in FIG. 2) are located between neighboring positive-bound zero-crossings. In the example shown in FIG. 2, the local maximum 222a is located between the first positive-bound zero-crossing and the second positive-bound zero-crossing, and the local maximum 222a is located at the 8^{th} sample. The local maximum 222b is located between the second positive-bound zero-crossing and the third positive-bound zero-crossing, and the local maximum 222b is located at the 15^{th} sample. The process continues until all local maxima (collectively, “222”) in the window are located. In the meantime, the overall maximum 212a among all local maxima 222 can be located by comparing the amplitude of all local maxima 222. In the example shown in FIG. 2, the overall maximum 212a is used as the benchmark, as described above, for calculating correlation.

At step 410, the local extrema 222 are screened. The lags or shifts between the overall maximum 212a and all local maxima 222 can form a lag set or a shift set. The lag set can be reduced by the following two aspects. On one hand, valid sample ranges are determined. The valid sample ranges correspond to a typical human pitch range. In the example shown in FIG. 2, the valid sample ranges, within the window between the 1^{st} sample and the 256^{th} sample, include a first valid sample range 252a and a second valid sample range 252b (collectively, the valid sample range(s) 252). The first valid sample range 252a is before the overall maximum 212a (as the benchmark as explained above), whereas the second valid sample range 252b is after the overall maximum 212b.

On the other hand, an amplitude threshold is determined. In the example shown in FIG. 2, the amplitude threshold 262 is shown as the horizontal dashed line, which is defined by a fraction (e.g., 0.55) of the magnitude of the overall maximum 212a. As such, the valid sample ranges 252 and the amplitude threshold 262 define a first target region 272a and a second target region 272b (collectively, the target region(s) 272). Only local maxima 222 within the first target region 272a and the second target region 272b are left after the screening. In other words, local maxima 222 (e.g., the local maxima 222a and 222b) outside the first target region 272a and the second target region 272b are screened out.

In the example shown in FIG. 2, only eleven local maxima 222 (i.e., the lag set denoted as a diamond shape in FIG. 2) are left after the screening based on the valid sample range(s) 252 and the amplitude threshold 262. This number is significantly smaller than the total number of local maxima 222. It should be understood that the number of local maxima 222 left will change accordingly as the valid sample range(s) 252 and the amplitude threshold 262. Since the complexity of autocorrelation calculation is O(n\hat{ }2), this reduction will simplify the autocorrelation calculation significantly.

In some embodiments, at step 412, the valid lag set after the screening at step 410 can be further reduced by only keeping a predetermined number N (e.g., 4) of lags (denoted as squares surrounding the diamonds, namely “−122”, “−81”, “−40” and “40” as shown in FIG. 2) with the highest N magnitude to form a “top lag set.” As such, the complexity of autocorrelation calculation is further reduced. It should be understood that the predetermined number N may vary in different implementations as needed. In some implementations, it may be advantageous to include the lag from previous window to the top lag set.

In some embodiments, at step 414, side lags can be added into the autocorrelation calculation. Since the actual pitch period 202 may not correspond to an integer number of samples, another predetermined number M (e.g., +/−1) of lags on each side (denoted by the two arrows pointing to the left and right around the selected lags, as shown in FIG. 2) of the candidate lags in the top lag set will be considered to ensure all potential maximum normalized autocorrelations will be considered to form an expanded lag set. Thus, an approximated maximum normalized autocorrelation can be obtained by selecting the maximum of the normalized autocorrelation according to the lags in the expanded lag set.

At step 416, the normalized autocorrelation function is calculated using the lags in the expanded lag set. As discussed above, after the amplitude threshold and valid sample range screening at step 410, the top lag selection at step 412, and the side tag expansion at step 414, the normalized autocorrelation function becomes an approximation with reduced computational complexity without compromising the performance considerably. As described above, the autocorrelation function calculation is implemented by calculating the degree of similarity between the audio signal waveform and its shifted versions. In some implementations, the degree of similarity is characterized by the inner product operation. The autocorrelation is then normalized to obtain the normalized autocorrelation function. After being normalized, the autocorrelation values are scaled between zero and one, with a value of zero indicating no correlation and a value of one indicating perfect correlation (i.e., complete overlap). In the example shown in FIG. 4, at most (N+1)*(2M+1) normalized autocorrelations are calculated.

At step 418, the maximum normalized autocorrelation (MNAC) is then obtained from the normalized autocorrelation. As described above, the maximum normalized autocorrelation refers to the highest peak value obtained when calculating the normalized autocorrelation function. In the example shown in FIG. 4, the MNAC is picked from the at most (N+1)*(2M+1) normalized autocorrelations calculated at step 416. As an example (i.e., Example #1, with the amplitude threshold being 0.55, as shown in FIG. 1B and FIG. 1C), if N is four and M is one, then the MNAC is picked from at most fifteen. As another example (i.e., Example #2, with the amplitude threshold being 0.5, as shown in FIG. 1B and FIG. 1C), if N is five and M is two, then the MNAC is picked from at most thirty.

Referring back to FIG. 1, as shown in FIG. 1B, the approximated normalized autocorrelation function in Example #1 (N is four and M is one) and the approximated normalized autocorrelation function in Example #2 (N is five and M is two) exhibit good performance, achieving close approximation at peak locations as compared to the result without approximation (denoted as “all lags” in FIG. 1B). Although the approximation in Example #2 is slightly better than the approximation in Example #1, the approximation in Example #1 requires the calculation of fewer normalized autocorrelations. FIG. 1C shows the number of normalized autocorrelations required to be calculated. Example #1 can save some computational resources without substantially compromising the approximation accuracy.

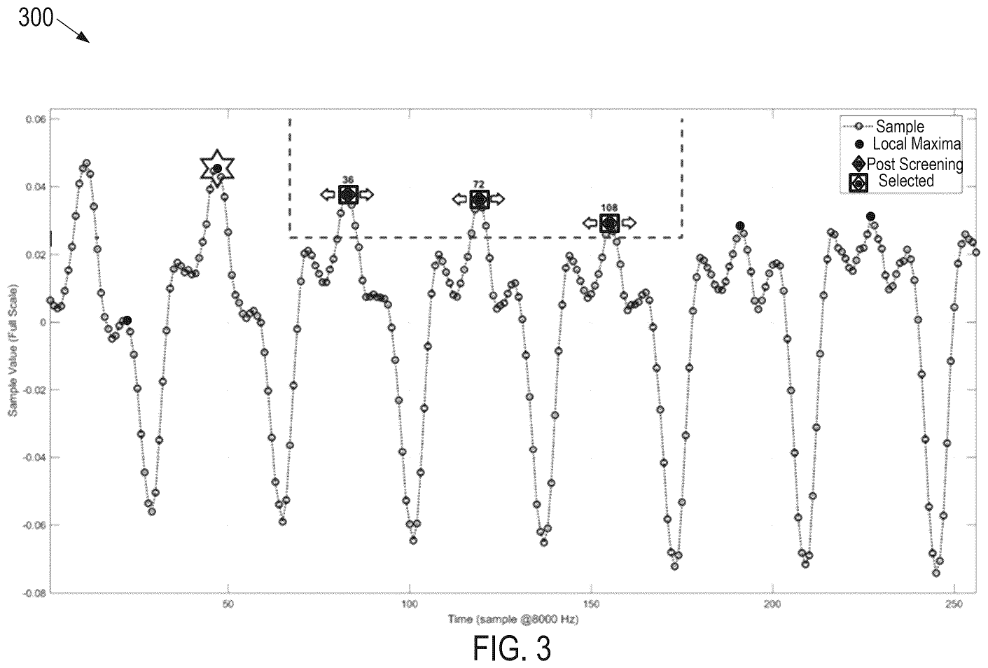

FIG. 3 depicts another windowed waveform 300 with fewer zero-crossings in another example in accordance with some aspects of the present disclosure. There are fewer zero-crossings mainly due to its low first formant (F1), which is the frequency with the lowest energy peak in the sound spectrum of a vowel. It is noted that even the predetermined number N is set as four, only three valid local maxima are kept. Nevertheless, the lag with potential maximum normalized autocorrelation (with the lag or shift of “+36” as shown in FIG. 3) is still in the top lag set. Thus, the maximum normalized autocorrelation (MNAC) can be accurately obtained without searching through all lags within the valid range (i.e., the 20^{th} sample to the 128^{th} sample).

Although local maxima are sought and then selected to find candidate lags in the examples described above, it should be understood that local minima can be also used for the same purpose (i.e., the calculation of normalized autocorrelation) in other implementations. In other words, local extrema (either local maxima or local minima) can be utilized depending on the circumstances. One of ordinary skill in the art would recognize many variations, modifications, and alternatives.

Similarly, although positive-bound zero-crossings are located to obtain local maxima or local minima, it should be understood that negative positive-bound zero-crossings may also be located to obtain local maxima or local minima in other implementations. One of ordinary skill in the art would recognize many variations, modifications, and alternatives.

Moreover, both waveforms in FIG. 2 and FIG. 3 have minimal direct current (DC) level, and the zero-crossings thus can be located properly. In the case of excessive DC level or offset, the input filter, shown in FIG. 4 and discussed above, is required to eliminate the DC offset. In some embodiments, a bandpass filter may be employed as long as the higher cutoff frequency is high enough to avoid false high autocorrelation.

Applicant has observed that the techniques disclosed herein is resistant to background noise. Even when the signal-to-noise ratios (SNRs) are not ideal, the maximum normalized autocorrelations (MNAC) are close to the ground truth maximum normalized autocorrelations (MNAC) without using the techniques disclosed herein.

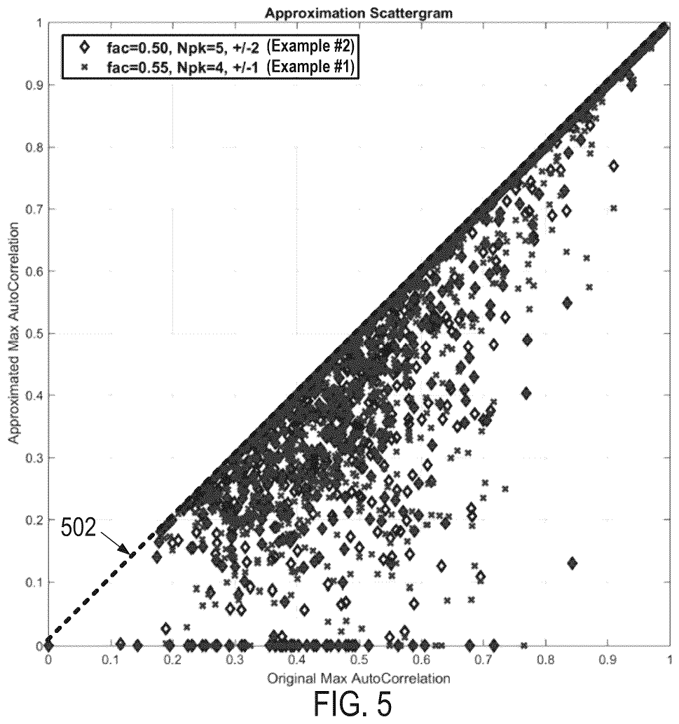

FIG. 5 depicts a scatter plot showing the distribution of the approximated maximum normalized autocorrelations (MNAC) with respect to the corresponding original maximum normalized autocorrelations (MNAC) according to some aspects of the present disclosure. The approximations are expected to be as close as the diagonal dashed line 502 (i.e., the mathematical function y=x) as shown in the plot. The same examples described above (i.e., Example #1 and Example #2) are shown in FIG. 5. Example #2 (which considers more lags) shows better approximation than Example #1 (which considers fewer lags). However, both are reasonably good when the ground truth is above 0.9.

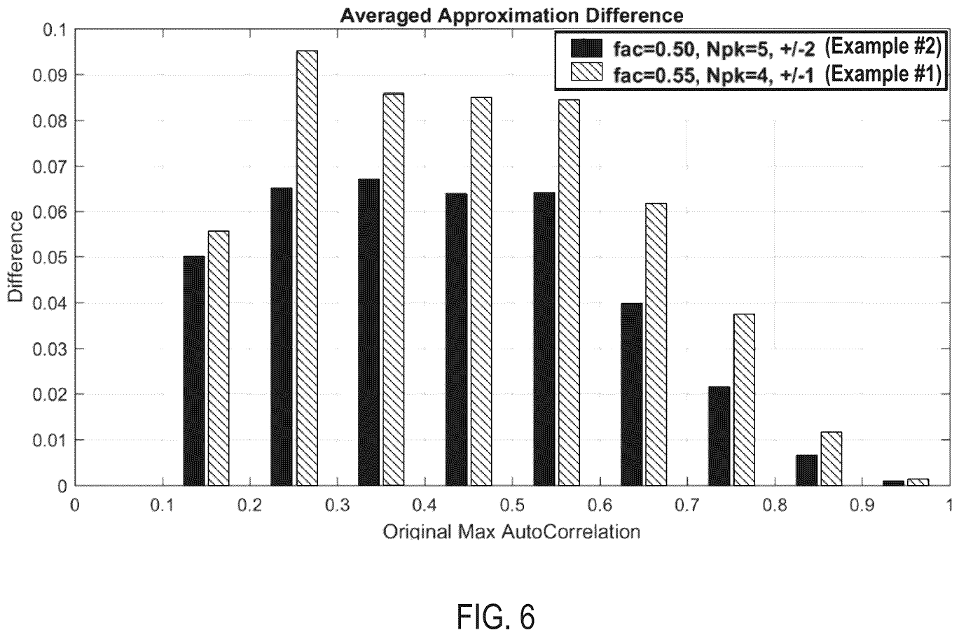

FIG. 6 depicts a bar graph showing the averaged differences between original maximum normalized autocorrelations and the corresponding approximations according to some aspects of the present disclosure. Example #2 (which considers more lags) shows less difference than Example #1 (which considers fewer lags).

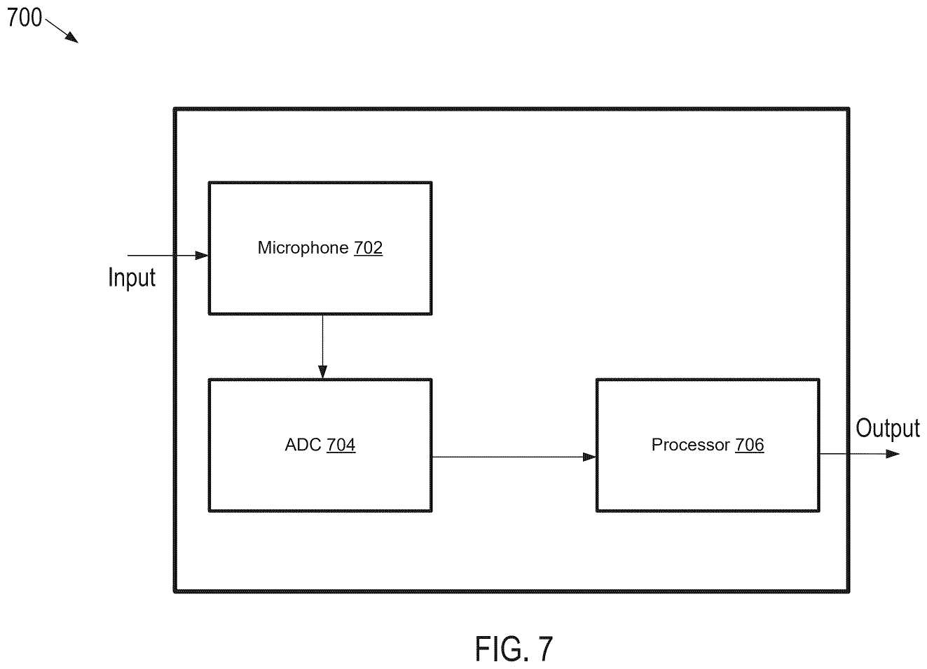

FIG. 7 depicts an example of a system 700 in accordance with some aspects of the present disclosure. The techniques described above can be implemented by the system 700 shown in FIG. 7. The system 700 is an audio signal processing system. The system 700 includes, among other components, a microphone 702, an ADC 704, and a processor 706. The microphone 702 is connect to the input terminal of the system 700 and receives an audio or acoustic signal. The ADC 704 is connected between the microphone 702 and the processor 706. The ADC 703 converts the acoustic signal into a digital form of the acoustic signal. The processor 706 receives the digital form of the acoustic signal and process it as described above. For example, the processor 706 may conduct the steps 404, 406, 408, 410, 412, 414, 416, and 418 shown in FIG. 4. The processor 706 may further, in some embodiments, analyze one or more pitch characteristics of the acoustic signal based on the approximated maximum normalized autocorrelation. The one or more pitch characteristics may include, among other things, the pitch period, the fundamental frequency, the tempo, the presence of echoes, the noise characteristics, and the like.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A system, comprising:
a microphone configured to receive an acoustic signal;
an analog-to-digital converter (ADC) connected to the microphone and configured to convert the acoustic signal into a digital form of the acoustic signal; and
a processor connected to the ADC and configured to:
trim a window of the digital form of the acoustic signal, the window being characterized by a first number of samples;
locate positive-bound zero-crossings or negative-bound zero-crossings of the digital form of the acoustic signal within the window;
locate local maxima or local minima between each of the two neighboring positive-bound zero-crossings or between each of the two neighboring negative-bound zero-crossings;
identify an overall maximum from the local maxima or an overall minimum from the local minima;
determine at least one valid sample range;
determine an amplitude threshold;
screen the local maxima or the local minima based on the at least one valid sample range and the amplitude threshold to identify a first set of local maxima or a first set of local minima;
select a second number of top local maxima from the first set of local maxima or a second number of bottom local minima from the first set of local minima, samples corresponding to the second number of top local maxima defining a first set of lags with respect to the overall maximum, or samples corresponding to the second number of bottom local minima defining the first set of lags with respect to the overall minimum;
expand the first set of lags by including a third number of neighboring samples of the samples corresponding to the second number of top local maxima or a third number of neighboring samples of the samples corresponding to the second number of bottom local minima;
calculate normalized autocorrelations based on the expanded first set of lags; and
determine an approximated maximum normalized autocorrelation based on the calculated normalized autocorrelations.

2. The system of claim 1, wherein the at least one valid sample range corresponds to a typical human pitch range.

3. The system of claim 1, wherein the at least one valid sample range and the amplitude threshold define at least one target region.

4. The system of claim 3, wherein screening the local maxima or the local minima is based on the at least one target region, and local maxima outside the at least one target region or local minima outside the at least one target region are screened out.

5. The system of claim 1, wherein the first set of lags further comprises previous lags.

6. The system of claim 1, wherein the second number is between four and five.

7. The system of claim 1, wherein the third number is between two and four.

8. The system of claim 1, wherein the processor is further configured to:
analyze one or more pitch characteristics of the acoustic signal based on the approximated maximum normalized autocorrelation.

9. A method, comprising:
obtaining a digital form of an acoustic signal;
trimming a window of the digital form of the acoustic signal, the window being characterized by a first number of samples;
locating positive-bound zero-crossings or negative-bound zero-crossings of the digital form of the acoustic signal within the window;
locating local maxima or local minima between each of the two neighboring positive-bound zero-crossings or between each of the two neighboring negative-bound zero-crossings;
identifying an overall maximum from the local maxima or an overall minimum from the local minima;
determining at least one valid sample range;
determining an amplitude threshold;
screening the local maxima or the local minima based on the at least one valid sample range and the amplitude threshold to identify a first set of local maxima or a first set of local minima;
selecting a second number of top local maxima from the first set of local maxima or a second number of bottom local minima from the first set of local minima, samples corresponding to the second number of top local maxima defining a first set of lags with respect to the overall maximum, or samples corresponding to the second number of bottom local minima defining the first set of lags with respect to the overall minimum;
expanding the first set of lags by including a third number of neighboring samples of the samples corresponding to the second number of top local maxima or a third number of neighboring samples of the samples corresponding to the second number of bottom local minima;
calculating normalized autocorrelations based on the expanded first set of lags; and
determining an approximated maximum normalized autocorrelation based on the calculated normalized autocorrelations.

10. The method of claim 9, wherein obtaining the digital form of the acoustic signal comprises:
receiving, by a microphone, the acoustic signal; and
converting, by an analog-to-digital converter (ADC) connected to the microphone, the acoustic signal into the digital form of the acoustic signal.

11. The method of claim 9, wherein the at least one valid sample range corresponds to a typical human pitch range.

12. The method of claim 9, wherein the at least one valid sample range and the amplitude threshold define at least one target region.

13. The method of claim 12, wherein screening the local maxima or the local minima is based on the at least one target region, and local maxima outside the at least one target region or local minima outside the at least one target region are screened out.

14. The method of claim 9, wherein the first set of lags further comprises previous lags.

15. The method of claim 9, wherein the second number is between four and five.

16. The method of claim 9, wherein the third number is between two and four.

17. The method of claim 9, further comprising:
analyzing one or more pitch characteristics of the acoustic signal based on the approximated maximum normalized autocorrelation.

18. A system, comprising:
a microphone configured to receive an acoustic signal;
an analog-to-digital converter (ADC) connected to the microphone and configured to convert the acoustic signal into a digital form of the acoustic signal; and
a processor connected to the ADC and configured to:
locate positive-bound zero-crossings or negative-bound zero-crossings of the digital form of the acoustic signal;
locate local maxima or local minima between each of the two neighboring positive-bound zero-crossings or between each of the two neighboring negative-bound zero-crossings;
identify an overall maximum from the local maxima or an overall minimum from the local minima;
determine at least one valid sample range;
determine an amplitude threshold;
screen the local maxima or the local minima based on the at least one valid sample range and the amplitude threshold to identify a first set of local maxima or a first set of local minima;
select a second number of top local maxima from the first set of local maxima or a second number of bottom local minima from the first set of local minima, samples corresponding to the second number of top local maxima defining a first set of lags with respect to the overall maximum, or samples corresponding to the second number of bottom local minima defining the first set of lags with respect to the overall minimum;
calculate normalized autocorrelations based on the first set of lags; and
determine an approximated maximum normalized autocorrelation based on the calculated normalized autocorrelations.

19. The system of claim 18, wherein the processor is further configured to:
expand the first set of lags by including a third number of neighboring samples of the samples corresponding to the second number of top local maxima or a third number of neighboring samples of the samples corresponding to the second number of bottom local minima.

20. The system of claim 18, wherein the at least one valid sample range and the amplitude threshold define at least one target region.
